(19) United States
(12) Patent Application Publication
(10) Pub. No.: US 2019/0044112 A1
(43) Pub. Date: Feb. 7, 2019

(54) BATTERY PACK

(71) Applicant: Robert Bosch GmbH, Stuttgart (DE)

(72) Inventors: Christoph Klee, Stuttgart (DE); Marcin Rejman, Waiblingen (DE)

(21) Appl. No.: 16/050,841

(22) Filed: Jul. 31, 2018

(30) Foreign Application Priority Data
Aug. 1, 2017 (DE) 102017213307.4

(51) Int. Cl. H01M 2/10; H01M 2/04; H01M 10/42; H01M 10/48

(52) U.S. Cl. CPC H01M 2/1055; H01M 2/0404; H01M 2010/4271; H01M 10/488; H01M 2220/30; H01M 10/425

(57) ABSTRACT

A handheld power tool battery pack included a housing in which at least one battery cell and an electronic system including a circuit board are situated, at least one light emitting element being situated on the circuit board. An elastic and transparent protection element is situated between the at least one light emitting element and the housing.

### CROSS-REFERENCE TO RELATED APPLICATIONS

The present application claims priority under 35 U.S.C. § 119 to DE 10 2017 213 307.4, filed in the Federal Republic of Germany on Aug. 1, 2017, the content of which is hereby incorporated by reference herein in its entirety.

### FIELD OF THE INVENTION

The present invention relates to a battery pack including a housing in which at least one battery cell and an electronic system including a circuit board are situated, with at least one light emitting element being situated on the circuit board, where an elastic and transparent protection element is situated between the at least one light emitting element and the housing.

### BACKGROUND

Battery packs are already known which include circuit boards having light emitting diodes and which have various measures available, such as a protective coating in the form of an insulating varnish or the installation of transparent sealing compounds for the purpose of protecting the circuit boards from conductive contaminants, such as dust or moisture.

### SUMMARY

The present invention relates to a battery pack, in particular a handheld power tool battery pack including a housing in which at least one battery cell and an electronic system including a circuit board are situated, at least one light emitting element being situated on the circuit board. It is provided that an elastic and transparent protection element is situated between the at least one light emitting element and the housing. The service life of the electronic system can thus be advantageously increased.

The housing of the battery pack preferably includes a mechanical interface via which the housing of the battery pack is detachably connectable to a consumer and/or a charging device. The consumer can be in particular designed as a gardening tool, for example a lawn mower or a hedge trimmer, as a handheld power tool, for example an angle grinder, a screwdriver, a drill, a percussion drill, etc., or as a measuring tool, for example a laser rangefinder. Furthermore, it is also conceivable that the consumer is designed as a different, in particular a portable, device, for example a construction site lighting, a suction unit, or a construction site radio. The battery pack is connectable to the consumer via the mechanical interface in a force-fitted and/or a form-locked manner. The mechanical interface advantageously includes at least one actuating element via which the battery pack and the consumer are detachably connected. Furthermore, the battery pack includes at least one battery cell and an electrical interface via which the at least one battery cell is electrically connectable to the consumer. The battery cell can be implemented as a galvanic cell which has a design in the case of which one cell pole is situated at one end and a further cell pole is situated at an opposite end. In particular, the battery cell has a positive cell pole at one end and a negative cell pole at an opposite end. The battery cells are preferably designed as NiCd or NiMh battery cells, particularly preferably as lithium-based battery cells. The battery voltage of the battery pack is generally many times higher than the voltage of one individual battery cell and results from the circuit (parallel or in series) of the battery cells. In the case of conventional battery cells having a voltage of 3.6 V, battery voltages of 3.6 V, 7.2 V, 10.8 V, 14.4 V, 18 V, 36 V, 54 V, 108 V, etc. thus result, for example. The battery cell is preferably designed as an at least essentially cylinder-shaped round cell, the cell poles being situated at the ends of the cylinder shape. The electrical interface includes in particular at least two electrical contact elements which are designed to transmit power. Alternatively, the electrical interface can include a secondary charging coil element for inductive charging.

Additionally, the electrical interface can include further contact elements which are designed to transmit to the consumer additional information which can be ascertained via the electronic system, for example. In this case, a state of charge of the battery pack, a temperature within the battery pack, a coding, or a residual capacity of the battery pack can be involved. In addition, it is conceivable that the electronic system is designed to regulate or to control the charging and/or discharging process of the battery pack. The electronic system can, for example, include a circuit board, a processing unit, a transistor, a capacitor, and/or a memory. The electronic system can additionally include one or multiple sensor elements, for example for ascertaining the temperature within the battery pack. Alternatively or additionally, the electronic system can include a coding element, for example, a coding resistor.

The light emitting element is in particular designed to display a state of charge of the battery pack. The state of charge is in particular displayed via a state of display of the light emitting element. Additionally or alternatively, it is also conceivable that another operating parameter which is relevant for the operation of the battery pack is displayable via the light emitting element or via a further light emitting element. The operating parameter can for example involve the temperature of the battery pack or the presence of interferences. The state of display can for example involve a switched-on or a switched-off state of the light emitting element, an intensity, a color, or a modulation, for example, flashing. The battery pack preferably includes multiple light emitting elements. The light emitting element is preferably electrically and/or mechanically connected to the electronic system, in particular to the circuit board of the electronic system. The light emitting element is preferably situated in the housing of the battery pack in such a way that the state of display of the light emitting element is visible from the outside. In particular, the light emitting element is situated in the area of an opening in the housing or in the area of a window element which is recessed in the housing.

The protection element is preferably formed from a polymer. The protection element is in particular formed from a polymer film. Preferably, the thickness of the protection element is at least 1 mm, preferably at least 2 mm. The protection element is in particular elastically formed in such a way that it changes its shape under a force effect and essentially returns to its original shape when no longer subjected to the effecting force. The protection element is in particular designed to be compressible by at least 10% of its thickness, preferably by at least 25% of its thickness, preferably by at least 50% of its thickness. The protection element is preferably designed to be adhesive on at least one side. The protection element is designed to be transparent in such a way that at least 90%, preferably at least 50%, preferably at least 10% of the light emitted by the light emitting element passes through the protection element. The protection element is preferably designed to be essentially colorless.

Furthermore, it is provided that at least one operating element is situated on the circuit board. An operation of the light emitting element can thus advantageously be made possible. The operating element can be designed as a switch or as a button. The operating element is electrically and/or mechanically connected to the electronic system, in particular to the circuit board. The light emitting element is activatable by actuating the operating element.

It is furthermore provided that the protection element is in contact with the light emitting element and with the circuit board, in particular with the light emitting element, with the circuit board, and with the operating element. The protection of the electronic system can thus be advantageously improved. The protection element preferably applies a force to the circuit board at least partially, in particular completely.

In addition, it is provided that the protection element is in contact with the housing, in particular with a transparent area of the housing. Dust or moisture can thus be advantageously prevented from entering in the area of the electronic system. In particular, the protection element partially applies a force to the housing. Preferably, the protection element essentially completely applies a force to a housing part of the housing. Preferably, the protection element is crimped between the circuit board and the housing.

It is furthermore provided that the protection element is elastically designed in such a way that a mechanical load on the electronic system, in particular on the electronic system in the area of the light emitting element, is damped by the protection element. The protection of the electronic system is thus advantageously further improved. In the assembled state, the protection element is compressed in particular by maximally 10% of its maximum compression, preferably by maximally 25% of its maximum compression, preferably by maximally 50% of its maximum compression, whereby a mechanical load, when acting, can be advantageously damped by the protection element being further compressed.

It is furthermore provided that the protection element is elastically designed in such a way that the operating element is actuatable via a force on the housing. A cost-effective construction of the battery pack can thus be advantageously made possible.

In addition, it is provided that the size of the protection element is adapted to the circuit board and/or to the at least one light emitting element. A compact construction and a good protection can thus advantageously be made possible. The size of the protection element is in particular designed in such a way that all electronic components and electrical connections or contact points as well as the light emitting elements are covered by the protection element.

Furthermore, it is provided that the size of a side face of the protection element essentially corresponds to the size of a side face of the circuit board. This measure advantageously allows for the entire circuit board and the electronic components located on same to be effectively protected by the protection element.

It is furthermore provided that the size of the protection element is adapted to the size of a housing part of the housing. Advantageously, it can thus be ensured that dust does not enter the housing at the boundary surface between two housing parts connected to one another.

It is additionally provided that a thickness of the protection element corresponds at least to a height of the electronic system, in particular at least to a height of the operating element, or at least to a height of the light emitting element. The protection of the electronic system can thus be advantageously further improved with the aid of this measure.

Further advantages result from the example embodiments described in the following description of the drawings. The drawings, the description, and the claims contain numerous features in combination. Those skilled in the art will advantageously also consider the features individually and combine them to form other reasonable combinations.

### BRIEF DESCRIPTION OF THE DRAWINGS

FIG. 1 shows a perspective view of a battery pack according to an example embodiment of the present invention.

FIG. 2 shows a perspective view of the battery pack according to FIG. 1 with a partially removed housing, according to an example embodiment of the present invention.

FIG. 3 shows a cross section through a protection element according to an example embodiment of the present invention.

### DETAILED DESCRIPTION

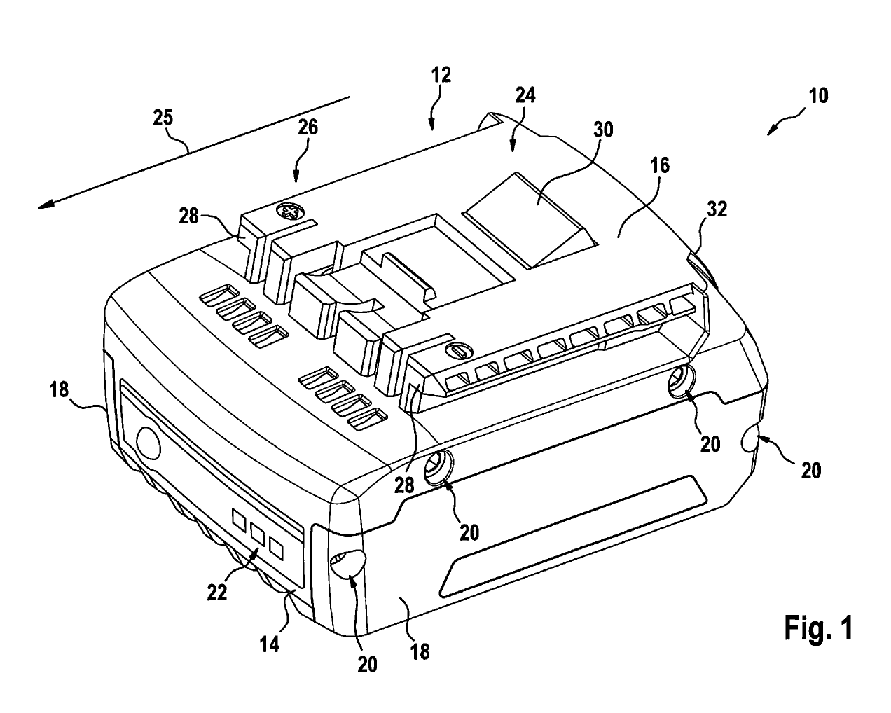

Referring to FIG. 1, a battery pack 10 is designed as a handheld power tool battery pack and is designed to be electrically and mechanically connectable to a handheld power tool (not illustrated) in such a way that the handheld power tool can be supplied with power via battery pack 10. The battery pack includes a housing 12 which has a multi-part design. On its bottom side, housing 12 includes a base body 14, on its top side, it includes an interface housing part 16, and on its side faces, it includes two opposite side walls 18. Housing 12 is designed as an outer housing. Housing parts 14, 16, 18 are connected to one another via screw connections 20. On the front side of battery pack 10, a state of charge display 22 is situated via which the state of charge of battery pack 10 is displayable. State of charge display 22 is integrated into housing 12, in particular into base body 14. Housing 12, in particular interface housing part 16, includes a mechanical interface 24 and an electrical interface 26. Mechanical interface 24 and electrical interface 26 are designed to be detachably installable without the use of tools and to electrically connect battery pack 10 to a handheld power tool or to a charging device (not illustrated), each having a corresponding mechanical and electrical interface.

Battery pack 10 is, for example, designed as a sliding battery pack. When attaching battery pack 10, accommodating means, for example guide grooves and guide ribs, of the handheld power tool or the charging device are engaged with corresponding guide elements 28 of battery pack 10 for the purpose of accommodating same, battery pack 10 being inserted in a sliding direction 25 along the accommodating means and mechanical interface 24 of battery pack 10 being slid into the corresponding mechanical interface of the handheld power tool or the corresponding interface of the charging device. To lock battery pack 10 to the handheld power tool or to the charging device, mechanical interface 24 includes a locking element 30. Locking element 30 is designed as a spring-loaded detent element which is pivotably situated in housing 12 of the battery pack. The locking takes place in that battery pack 10 is slid along sliding direction 25, locking element 30 locks into an undercut position at the end of the sliding movement. To release the locking, mechanical interface 24 includes an actuating element 32 which is movably coupled to locking element 30. By actuating actuating element 32, locking element 30 moves into housing 12 of battery pack 10 and the locking between the battery pack and the handheld power tool or the charging device is released.

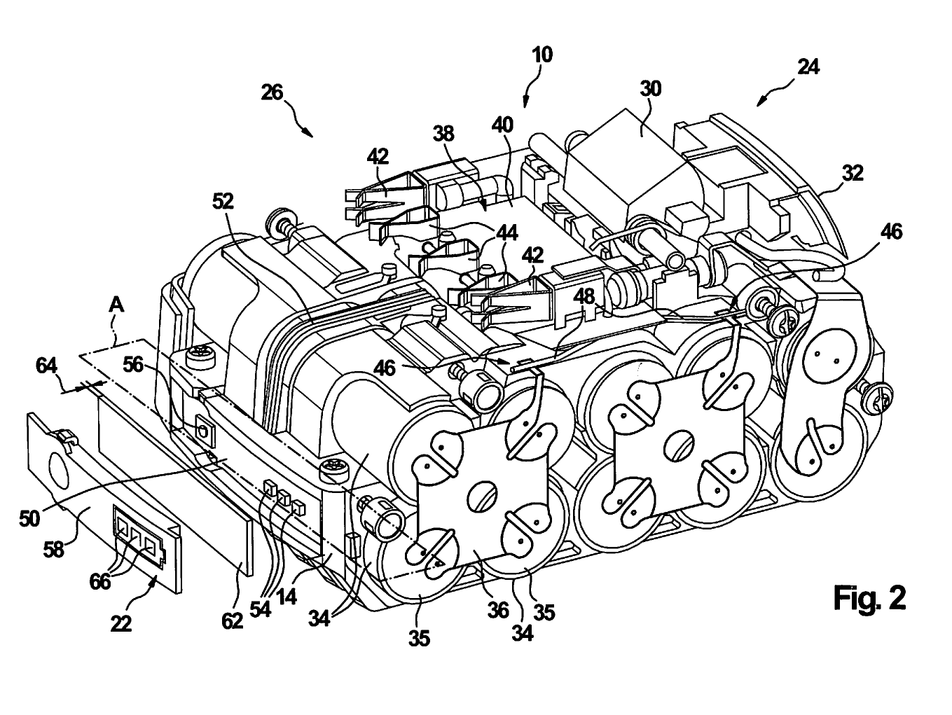

FIG. 2 shows battery pack 10 without interface housing part 16 and without side walls 18. Base body 14 of housing 12 has a cell holder area. In the cell holder area, at least one battery cell 34 is accommodated, battery pack 10 including, by way of example, ten battery cells 34 connected in parallel or in series in this specific embodiment. Alternatively, it is also conceivable that battery cells 34 are connected to one another with the aid of cardboard sleeves for insulating battery cells 34. Battery cells 34 are cylinder-shaped and include electric cell poles 35 at their front faces. The connection of battery cells 34 among one another is implemented via cell connectors 36. Cell connectors 36 are designed to electrically interconnect battery cells 34 among one another in parallel and/or in series. In the illustrated specific embodiment, two or four battery cells 34 are connected to one another in each case via cell connectors 36. Furthermore, it is apparent that individual battery cells 34 are accommodated spaced apart from one another for the purpose of mechanical fastening in the cell holder area of base body 14. In addition to fastening battery cells 34 in housing 12, the cell holder area is also used to cool battery cells 34 and is formed from a thermally conductive material, for example aluminum, or a sufficiently thermally conductive plastic. Furthermore, the cell holder area has sleeve-like insulation walls so that individual battery cells 34 are separated and an electrical insulation of individual battery cells 34 from one another can be ensured. The thermal transfer resistance between adjacent battery cells 34 and between battery cells 34 and the cell holder area is preferably low in this case so that the heat losses generated by battery cells 34 can be readily dissipated to the outside and battery pack 10 can be prevented from overheating on the inside.

An electronic system 38 is situated above the cell holder area, in particular in the area between base body 14 and interface housing part 16. Electronic system 38 includes a first circuit board 40. Electronic system 38 is connected to a second circuit board 50 which is assigned to state of charge display 22. On first circuit board 40, electrical contact elements 42 are situated which are provided for charging and discharging battery pack 10 and other contact elements 44 which are designed for transmitting state information, for example the state of charge or the temperature of battery pack 10, to the handheld power tool or the charging device. Electrical contact elements 42 and other contact elements 44 are assigned to electrical interface 26. Electrical contact elements 42 are connected to electronic system 38 and to battery cells 34. Electrical contact elements 42 and battery cells 34 are electrically connected via contact points 46 which are designed as solder joints and at which battery cells 34 are soldered to electrical connection elements 48, which are designed as wires, via cell connectors 36. Alternatively, it is also conceivable to weld cell connector 36 to electrical connection elements 48. Solder joints 46 are situated between electronic system 38 and battery cells 34. Solder joints 46 are in particular situated below electronic system 38 and above battery cells 34.

Second circuit board 50 is also assigned to electronic system 38. First circuit board 40 is connected to second circuit board 50 via a cable connection 52. Second circuit board 50 is essentially situated perpendicularly to first circuit board 40. During assembly, second circuit board 50 is inserted or clamped into housing 12, in particular into base body 14 of housing 12. Three light emitting elements 54 and one operating element 56 are situated on second circuit board 50. Light emitting elements 54 are in particular controlled via electronic system 38. Light emitting elements 54 are designed as light emitting diodes by way of example. The light emitting diodes can be designed in such a way that they emit monochromatic light or light in different colors. A fully charged battery is, for example, displayed via three activated green light emitting elements 54 and an empty battery is displayed via an activated red or green light emitting element 54. Operating element 56 is designed as a button and connected to electronic system 38. When operating element 56 is actuated, light emitting elements 54 are controlled via electronic system 38 in such a way that the instantaneous state of charge of battery pack 10 is displayed via light emitting elements 54. Light emitting elements 54 are preferably deactivated again after a few seconds.

In the area of second circuit board 50, housing 12 includes a further housing part 58 which is connectable to base body 14. The connection between base body 14 and further housing part 58 takes place in particular via a force-fitted and form-locked connection. Further housing part 58 is preferably clicked into base body 14. Base body 14 and further housing part 58 span a space in which second circuit board 50 is accommodated. A protection element 62 which is designed to protect electronic system 38, in particular second circuit board 50, from dust and/or liquid, is situated within that space.

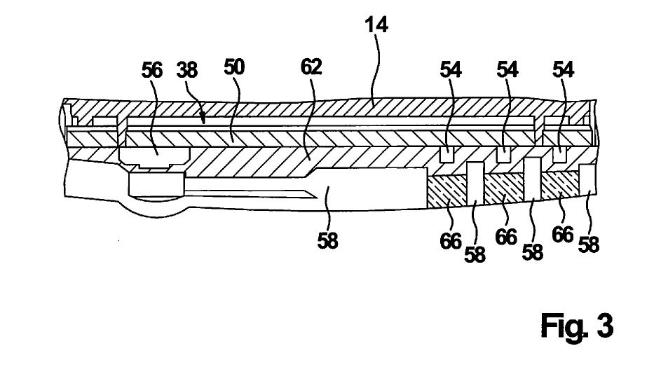

In FIG. 3, a cross section through plane A is shown which is plotted in FIG. 2. Protection element 62 is situated between electronic system 38 and housing 12 in such a way that on its one side, it is in contact with second circuit board 50, light emitting elements 54, and operating element 56, and on the opposite side, it is in contact with further housing part 58. Protection element 62 has an essentially uniform thickness 64 prior to the assembly. In the assembled state, protection element 62 is compressed between electronic system 38 and housing 12. By way of example, protection element 62 is essentially compressed at each point, thus resulting in advantageous consequences for the damping effect of protection element 62. It is also conceivable, however, that protection element 62 is compressed only sectionally. For example, the extent of the compression varies in a range between approximately 5% and 50% of thickness 64 of protection element 62. Protection element 62 is additionally integrally bonded to light emitting elements 54 and to second circuit board 50. Protection element 62 is designed to be adhesive on one side. In particular, one side face of protection element 62, which has an adhesive surface coating, is in contact with light emitting elements 54 and with second circuit board 50.

For the light emitted by light emitting elements 54 to be perceivable from the outside, housing 12 and further housing part 58 includes openings, in which window elements 66 are situated, in the area of light emitting elements 54. Window elements 66 are formed by a transparent plastic by way of example. Further housing part 58 is advantageously designed in one piece with window element 66 with the aid of a multi-component injection molding process. Alternatively, it is also conceivable that window elements 66 are designed as a transparent diaphragm which is connectable to further housing part 58 in a force-fitted and/or form-locked manner.

What is claimed is:

1. A battery pack comprising:
a housing;
at least one battery cell arranged in the housing;
an electronic system arranged in the housing and including a circuit board and at least one light emitter arranged on the circuit board; and
an elastic and transparent protector arranged between the at least one light emitter and the housing.

2. The battery pack of claim 1, wherein the battery pack is a handheld power tool battery pack.

3. The battery pack of claim 1, wherein the electronic system includes at least one operating element arranged on the circuit board.

4. The battery pack of claim 3, wherein the protector is in contact with the light emitter, the circuit board, and the operating element.

5. The battery pack of claim 1, wherein the protector is in contact with the light emitter and with the circuit board.

6. The battery pack of claim 1, wherein the protector is in contact with the housing.

7. The battery pack of claim 1, wherein the protector is in contact with a transparent area of the housing.

8. The battery pack of claim 1, wherein the electronic system and the protector are arranged relative to each other so that a mechanical load on the electronic system is dampenable by an elasticity of the protector.

9. The battery pack of claim 1, wherein the electronic system and the protector are arranged relative to each other so that a mechanical load on the electronic system in an area of the light emitter is dampenable by an elasticity of the protector.

10. The battery pack of claim 1, wherein, due to an elasticity of the protector, a force on the housing is transmittable via the protector to actuate the operating element.

11. The battery pack of claim 1, wherein a planar extension of the protector is essentially the same as a planar extension of the circuit board.

12. The battery pack of claim 1, wherein the protector covers an entirety of a front face of the at least one light emitter.

13. The battery pack of claim 1, wherein a side face of the protector covers at least essentially an entirety of a side face of the circuit board.

14. The battery pack of claim 1, wherein the housing includes a first housing part behind the circuit board, which is arranged behind the protector, and a second housing in front of the protector, and a planar extension of the protector is essentially the same as a planar extension of the second housing part.

15. The battery pack of claim 1, wherein a thickness of the protector is at least as great as a height of the operating element.

16. The battery pack of claim 1, wherein a thickness of the protector is at least as great as a height of the light emitter.
